(19) United States
(12) Patent Application Publication
(10) Pub. No.: US 2025/0014557 A1
(43) Pub. Date: Jan. 9, 2025

(54) MUFFLING DEVICE AND REFRIGERATING AND FREEZING APPARATUS

(71) Applicants: QINGDAO HAIER REFRIGERATOR CO., LTD., Qingdao, Shandong (CN); HAIER SMART HOME CO., LTD., Qingdao, Shandong (CN)

(72) Inventors: Yanbin WAN, Qingdao, Shandong (CN); Jianquan CHEN, Qingdao, Shandong (CN); Haijuan WANG, Qingdao, Shandong (CN); Wenjing CAI, Qingdao, Shandong (CN); Yang LIU, Qingdao, Shandong (CN)

(21) Appl. No.: 18/713,499

(22) PCT Filed: Oct. 24, 2022
(86) PCT No.: PCT/CN2022/127031

§ 371 Date: May 24, 2024

(30) Foreign Application Priority Data
Nov. 26, 2021 (CN) 202111421827.6

(51) Int. Cl. G10K 11/16; F25D 23/00

(52) U.S. Cl. CPC G10K 11/161; F25D 23/00; F25D 2201/30

(57) ABSTRACT

A muffling device includes a muffling body, the muffling body having a sound ingress and egress surface, at least one muffling chamber is provided inside the muffling body, the sound ingress and egress surface is provided with at least one communication port, each of the communication port connecting one or more of the muffling chamber, each of the muffling chamber is connected to the outside of the sound ingress and egress surface through at least one of the communication port. When noise passes through the through-holes of the muffling device, the sound is transmitted through the communication ports into the muffling chamber, extending the sound propagation path, weakening the sound energy, and thereby reducing the sound that continues to disperse outward. Specifically, the length of at least one muffling chamber is between 0.0085 m to 0.85 m.

### CROSS-REFERENCE TO RELATED APPLICATIONS

The present application is a national phase entry of International Application No. PCT/CN2022/127031, filed Oct. 24, 2022, which claims priority to Chinese Patent Application No. 202111421827.6, filed Nov. 26, 2021, which are incorporated herein by reference in their entirety.

### TECHNICAL FIELD

This application refers to a field of refrigeration storage technology, specifically relating to a muffling device and a refrigerating and freezing apparatus.

### BACKGROUND

With the advancement of science and technology, economic development, and the improvement of people's living standards, a high quality of life has become a necessary demand for users. In particular, refrigerators and freezers have become indispensable in household life, with users often storing most of their food items inside refrigerators. However, refrigerators may generate significant noise during operation. When users are near the refrigerator, they can clearly hear the noise produced by the appliance, which affects their normal life. The main sources of noise in refrigerators comprise mechanical noise, electromagnetic noise, and fluid noise, with the first two related to specific components and having more mature noise reduction measures. Fluid noise mainly comprises duct noise. The technology for noise reduction in individual fans has reached a bottleneck. Common refrigerator noise reduction materials comprise sound-absorbing cotton, which is effective against higher frequency noise but its noise reduction capacity is limited by its inherent properties, making it very limited against low-frequency noise. In specific spaces within ducts, thickness is often limited, and if sound-absorbing cotton does not meet the designed thickness requirements, it does not achieve a good effect.

Reference to any prior art in the specification is not, and should not be taken as, an acknowledgment or any form of suggestion that this prior art forms part of the common general knowledge in US or any other jurisdiction or that this prior art could reasonably be expected to be understood and regarded as relevant by a person skilled in the art.

### SUMMARY

In view of the above problems, the present application proposes a muffling device and a refrigerating and freezing apparatus that overcomes or at least partially resolves these problems by reducing noise.

The present application provides a muffling device, comprising a muffling body, the muffling body having a sound ingress and egress surface, at least one muffling chamber is provided inside the muffling body, the sound ingress and egress surface is provided with at least one communication port, each of the communication port connecting one or more of the muffling chamber, each of the muffling chamber is connected to the outside of the sound ingress and egress surface through at least one of the communication port.

As a further improvement of an embodiment of the present application, a length of at least one of the muffling chamber is between 0.0085 m and 0.85 m.

As a further improvement of an embodiment of the present application, the muffling body is provided with a through-hole, a hole wall of the through-holes being the sound ingress and egress surface.

As a further improvement of an embodiment of the present application, the muffling body is provided with a blind hole, a peripheral wall of the blind holes being the sound ingress and egress surface; or,

the peripheral wall and bottom wall of the blind hole being the sound ingress and egress surface.

As a further improvement of an embodiment of the present application, one external surface of the muffling body is the sound ingress and egress surface.

As a further improvement of an embodiment of the present application, a total area of the communication port in relation to an area of the sound ingress and egress surface has a ratio greater than 3%.

As a further improvement of an embodiment of the present application, the total area of the communication ports in relation to the area of the sound ingress and egress surface has a ratio greater than 3% and less than 7%.

As a further improvement of an embodiment of the present application, at least one of the muffling chambers is labyrinthine; the lengths of at least two of the muffling chambers are unequal, and the lengths of these two muffling chambers are between 0.0085 m and 0.85 m.

As a further improvement of an embodiment of the present application, each of the communication ports connects to one of the muffling chambers, each of the muffling chambers is connected to the outside of the sound ingress and egress surface through one of the communication ports.

The present application provides a refrigerating and freezing apparatus, comprising a cabinet and any one of the muffling devices according to any of the above embodiments; the muffling device is installed in the cabinet, to allow noise to enter the corresponding the muffling chambers through the communication ports.

As a further improvement of an embodiment of the present application, the cabinet is provided with an airflow hole for airflow through, the sound ingress and egress surface of the muffling device being part or all of a periphery wall surface of the airflow hole; and/or,

the cabinet is provided with an airflow channel for airflow through, the sound ingress and egress surface of the muffling device being part of a peripheral wall surface of the airflow channel.

In the muffling device and refrigerating and freezing apparatus of this application, when noise passes through the through-holes of the muffling device, sound is transmitted through the communication ports into the muffling chamber, extending the sound propagation path, weakening the sound energy, and reducing the sound that continues to spread outward. Specifically, the length of the muffling chamber is set so that the incident sound waves and the reflected sound waves at the communication port of the muffling chamber overlap with approximately equal amplitude and a phase reversal of 180°, as much as possible, to cancel each other out, achieving the purpose of silencing or noise reduction.

Furthermore, in the muffling device and refrigerating and freezing apparatus of this application, a ratio of the total area of the communication ports to the area of the sound ingress and egress surface is set to significantly enhance the noise reduction effect.

A detailed description of specific embodiments of this application, in conjunction with the drawings, will make the above and other objectives, advantages, and features of this application more apparent to those skilled in the art.

As used herein, except where the context clearly requires otherwise, the term “comprise” and variations of the term, such as “comprising”, “comprises” and “comprised”, are not intended to exclude further features, components, integers or steps.

### BRIEF DESCRIPTION OF DRAWINGS

The following text describes some specific embodiments of this application in a manner that is exemplary rather than limiting, with reference to the drawings. The same reference numerals in the drawings denote the same or similar parts or components. It should be understood by those skilled in the art that these drawings are not necessarily drawn to scale. In the drawings:

FIG. 1 is a schematic structural diagram of a muffling device according to an embodiment of the present application;

FIG. 2 is a schematic internal structure diagram of the muffling device shown in FIG. 1;

FIG. 3 is a schematic expanded view of the through-holes of the muffling device according to an embodiment of the present application;

FIG. 4 is a schematic comparison diagram of the sound absorption effect of the muffling device according to an embodiment of the present application;

FIG. 5 is a schematic diagram of the sound absorption effect of the muffling device according to an embodiment of the present application;

FIG. 6 is a schematic structural diagram of a refrigerating and freezing apparatus according to an embodiment of the present application;

FIG. 7 is a schematic partial structure diagram of the refrigerating and freezing apparatus shown in FIG. 6;

FIG. 8 is a schematic noise reduction effect comparison diagram of the refrigerating and freezing apparatus according to an embodiment of the present application.

### DETAILED DESCRIPTION OF EMBODIMENTS

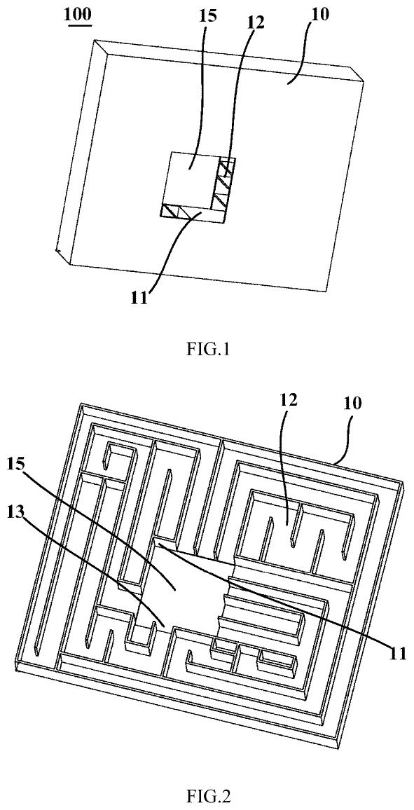

Referencing FIGS. 1 to 8, this section describes embodiments of the muffling device and refrigerating and freezing apparatus of the present application. It should be understood in the description of these embodiments that terms such as “first,” “second” are used only for purposes of description and should not be interpreted as indicating or implying relative importance or implicitly specifying the number of technical features indicated. Thus, features described as “first,” “second” may explicitly or implicitly comprise one or more of such features. In the description of the present application, “multiple” means at least two, for example, two, three, etc., unless otherwise specifically defined. When a feature is said to “comprise” or “include” certain components, unless specifically stated otherwise, it does not preclude the presence of other components.

Unless specifically defined or limited, terms such as “provided,” “installed,” “connected,” “coupled,” and the like should be understood in a broad sense. For instance, they can mean a fixed connection, a detachable connection, or an integral construction; mechanical or electrical connections; direct or indirect connections through intermediate media; or the interaction or communication between two components. Persons skilled in the art can understand the specific meanings of these terms in the context of the present application.

Furthermore, in the description of these embodiments, when a first feature is “on,” “above,” or “over” a second feature, it comprises cases where the first and second features are in direct contact, and cases where the first and second features are not in direct contact with each other but instead are communicated through another feature. Similarly, “below,” “beneath,” or “underneath” should comprise both direct and indirect configurations, where a first feature may be either directly below, beneath, or indirectly communicated with a second feature.

The terms “an embodiment,” “some embodiments,” “an example,” “a specific example,” or “some examples” mean that a particular feature, structure, material, or characteristic described in connection with the embodiment or example is comprised in at least one embodiment or example of the application. In this document, the schematic expressions of these terms do not necessarily refer to the same embodiment or example. Moreover, the described features, structures, materials, or characteristics may be combined in any suitable manner in one or more embodiments or examples.

FIG. 1 illustrates a schematic structural diagram of a muffling device according to an embodiment of the present application, and referring to FIGS. 2 to 5, an embodiment of the present application provides a muffling device 100, comprising a muffling body 10. The muffling body 10 has a sound ingress and egress surface 11, at least one muffling chamber 12 is provided inside the muffling body 10. at least one communication port 13 is provided on the sound ingress and egress surface 11, each the communication port 13 connecting to one or multiple muffling chambers 12. Each muffling chamber 12 is connected to the outside of the sound ingress and egress surface 11 through at least one communication port 13. As sound passes through the muffling device 100, the sound travels through the sound ingress and egress surface 11 and enters the muffling chamber(s) 12 via the communication ports 13 on the sound ingress and egress surface 11. Some or all portion of the muffling chambers 12 may be labyrinth-like, with a certain depth, thereby extending the sound's propagation path and achieving noise reduction through this acoustic meta-structure. Preferably, each communication port 13 connects to a muffling chamber 12, and each muffling chamber 12 is connected to the outside of the sound ingress and egress surface 11 through one communication port 13.

Specifically, the length of at least one muffling chamber 12 is between 0.0085 m to 0.85 m. Based on λ=c/f, where c is the speed of sound, in an air medium, when the wavelength of the incident sound wave is λ/4, the incident sound wave and the reflected sound wave overlap at the exit, with amplitudes as equal as possible and phases inverted by 180° as much as possible, thus maximizing sound wave cancellation and achieving the purpose of muffling and noise reduction. Furthermore, in the noise spectrum, more than 80% of sound energy is concentrated in the 100 Hz˜10000 Hz, less than 20% of sound energy is concentrated in the frequency ranges of 20 Hz˜100 Hz and 10000 Hz˜20000 Hz which is audible frequencies to the human ear, hence setting the length of at least one muffling chamber 12 to be between 0.0085 m to 0.85 m. The length of muffling chamber 12 can match the wavelength of the target muffling frequency, and one muffling chamber 12 can eliminate a corresponding specific frequency, typically, the length of a muffling chamber 12 can be ¼ of the corresponding wavelength.

Moreover, the lengths of muffling chambers 12 within the same muffling device 100 can be at least two, preferably multiple, and all within the range of 0.0085 m to 0.85 m. For instance, the lengths of multiple muffling chambers 12 can be 0.085 m, 0.01 m, 0.1 m, 0.5 m, etc. Of course, some of the lengths of muffling chambers 12 within the same muffling device 100 can be within the range of 0.0085 m to 0.85 m, while others may not fall within this range.

The length of muffling chamber 12 refers to the distance from the end of each muffling chamber 12 to its corresponding communication port 13. If each muffling chamber 12 is connected to the outside of the sound ingress and egress surface 11 through multiple communication ports, the length of muffling chamber 12 refers to the shortest of the distances between the end of each muffling chamber 12 and its corresponding multiple communication ports 13.

As shown in FIG. 4, the solid line represents the sound absorption coefficient of the muffling device 100 of the present application for different noise frequencies, while the dotted line represents the sound absorption coefficient of conventional sound-absorbing cotton. Clearly, the muffling device 100 is superior to conventional sound-absorbing cotton, especially when the noise frequency is between 200 Hz and 600 Hz. Compared to conventional sound-absorbing cotton, the sound absorption of the muffling device 100 of the present application is more exceptional, particularly suitable for mid to low-frequency noise reduction.

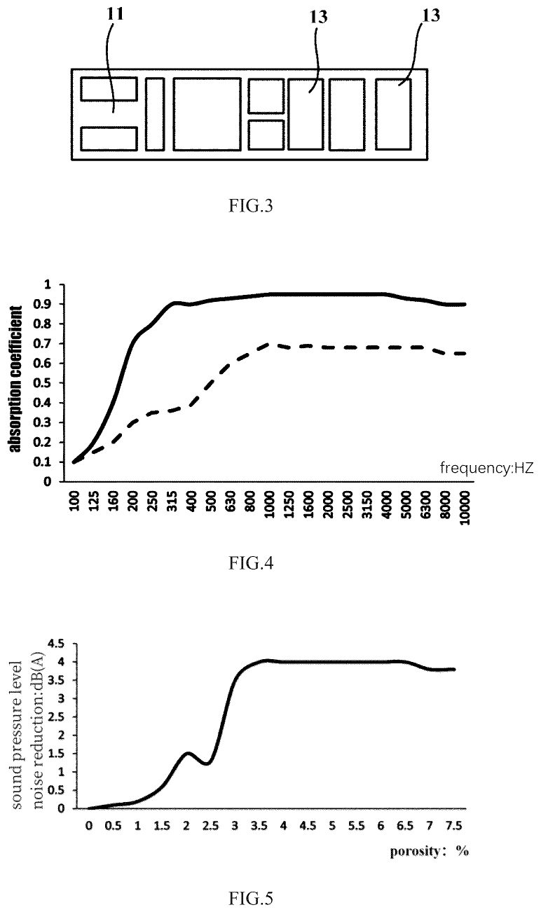

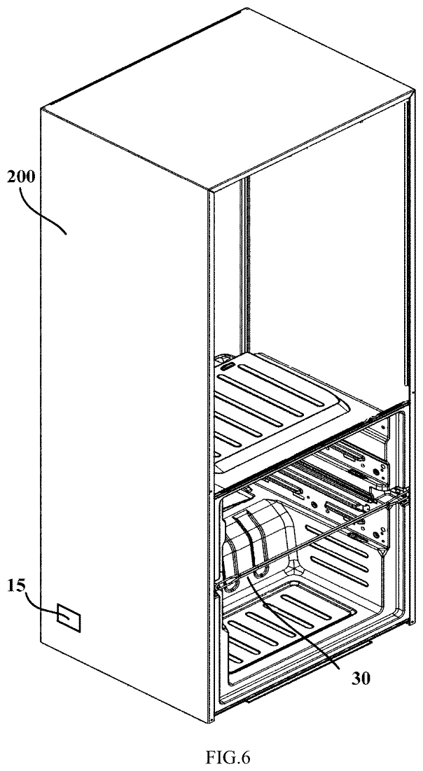

In some embodiments of the present application, as shown in FIGS. 2, 3, and 5, the total area of the communication ports 13 relative to the area of the sound ingress and egress surface 11 exceeds 3%. When there are multiple communication ports, the total area of communication ports 13 refers to the sum of the areas of all communication ports; when there is a single communication port, the total area of communication port 13 refers to the area of that single communication port. The area of the sound ingress and egress surface 11 comprises not only the total area of the communication ports 13 but also the area of the closed surfaces outside the communication ports. As illustrated in FIG. 3, the sound ingress and egress surface 11 is a rectangle, or when the sound ingress and egress surface 11 unfolded, the sound ingress and egress surface 11 is rectangular, its area being the area of the rectangle. Each communication port 13 is square, with the total area of communication ports 13 being the sum of the areas of multiple squares. When the ratio of the total area of communication ports 13 to the area of the sound ingress and egress surface 11 exceeds 3%, the noise reduction effect of the muffling device 100 is significantly improved, as shown in FIG. 5. Preferably, the ratio of the total area of communication ports 13 to the area of the sound ingress and egress surface 11 is greater than 3% and less than 7%. This ratio of the total area of communication ports 13 to the area of the sound ingress and egress surface 11 can also be referred to as the porosity of communication ports 13.

In some embodiments of the present application, the muffling body 10 is provided with through-holes 15, a hole wall of through-holes 15 can be the sound ingress and egress surface 11. Further, in some embodiments of the present application, the cross-section of through-holes 15 can be circular, square, triangular, or other regular polygons. In some embodiments, the muffling body 10 is provided with blind holes, a peripheral wall of the blind holes can be the sound ingress and egress surface 11; or, both the peripheral wall and bottom wall of the blind holes can be the sound ingress and egress surface 11.

In some embodiments of the present application, one external surface of the muffling body 10 is the sound ingress and egress surface 11. The muffling body 10 can be a rectangular or square prism or another hexahedron with two parallel sides, etc.

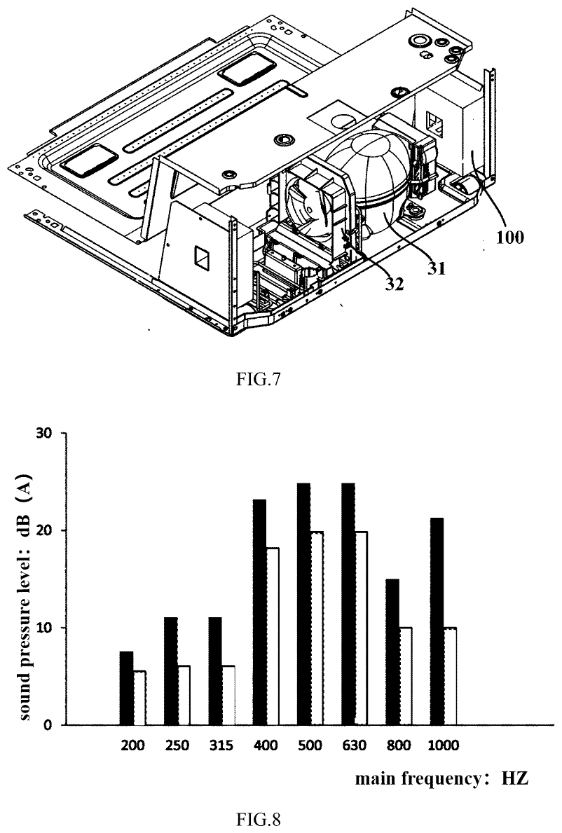

FIG. 6 illustrates a schematic structural diagram of a refrigerating and freezing apparatus according to an embodiment of the present application, FIG. 7 shows a schematic partial structural diagram of the refrigerating and freezing apparatus shown in FIG. 6, and FIG. 8 illustrates a schematic diagram comparing noise reduction effects of the refrigerating and freezing apparatus according to an embodiment of the present application. As shown in FIGS. 6 to 8, the present application also provides a refrigerating and freezing apparatus, which can be a refrigerator, freezer, etc. The refrigerating and freezing apparatus comprises a cabinet 200 and any one of the muffling devices 100 in the aforementioned embodiments. The muffling device 100 is installed in the cabinet 200, allowing noise to enter the corresponding muffling chambers 12 through communication port 13.

In some embodiments of the present application, the cabinet 200 has airflow holes through which airflow passes, and the sound ingress and egress surface 11 of the muffling device 100 constitutes part or all of the periphery wall surface of the airflow holes. Alternatively, the cabinet 200 has airflow channels through which airflow passes, and the sound ingress and egress surface 11 of the muffling device 100 constitutes part of the peripheral wall surface of the airflow channels. Or, the cabinet 200 may have both airflow holes and airflow channels.

In some embodiments of the present application, the cabinet 200 comprises a compressor chamber 30, airflow holes set on both side walls of the compressor chamber 30, the compressor chamber 30 corresponding to the muffling device 100, and the compressor chamber 30 is connected to the outside through the through-holes 15 of the muffling device 100. Inside the compressor chamber 30, a compressor 31 and a fan 32 are installed, the fan 31 inducing airflow through the through-holes 15 of the muffling device 100 on one side of the compressor chamber 30 and out through the through-holes 15 of the muffling device 100 on the other side, ensuring that airflow entering and exiting the compressor chamber 30 passes through the muffling device 100, thus ensuring noise reduction at both intake and exhaust locations. Particularly, as shown in FIG. 8, the sound pressure level (hollow column) of the refrigerating and freezing apparatus with the muffling device 100 of the present application is significantly lower than that of the refrigerating and freezing apparatus without the muffling device 100 (solid column), demonstrating the exceptional noise reduction effect of the muffling device 100 in any of the embodiments.

In some embodiments of the present application, the airflow channel serves to deliver airflow to the storage chamber inside the refrigerating and freezing apparatus, utilizing the muffling device 100 in any of the embodiments to reduce noise in the duct.

At this point, those skilled in the art should recognize that, although numerous exemplary embodiments of the present application have been shown and described in detail, various other modifications and variations that are consistent with the principles of the present application can be directly determined or derived from the disclosure of the present application without departing from the spirit and scope of the application. Therefore, the scope of the application should be understood and interpreted to cover all such other modifications and variations.

1. A muffling device, comprising a muffling body, the muffling body having a sound ingress and egress surface, at least one muffling chamber is provided inside the muffling body, the sound ingress and egress surface is provided with at least one communication port, each of the communication port connecting one or more of the muffling chamber, each of the muffling chamber is connected to the outside of the sound ingress and egress surface through at least one of the communication port.

2. The muffling device according to claim 1, wherein,
a length of at least one of the muffling chamber is between 0.0085 m and 0.85 m.

3. The muffling device according to claim 1, wherein,
the muffling body is provided with a through-hole, a hole wall of the through-hole being the sound ingress and egress surface.

4. The muffling device according to claim 1, wherein,
the muffling body is provided with a blind hole, a peripheral wall of the blind holes being the sound ingress and egress surface; or,
the peripheral wall and bottom wall of the blind hole being the sound ingress and egress surface.

5. The muffling device according to claim 1, wherein,
one external surface of the muffling body is the sound ingress and egress surface.

6. The muffling device according to claim 1, wherein,
a total area of the communication port in relation to an area of the sound ingress and egress surface has a ratio greater than 3%.

7. The muffling device according to claim 6, wherein,
the total area of the communication port in relation to the area of the sound ingress and egress surface has a ratio greater than 3% and less than 7%.

8. The muffling device according to claim 1, wherein,
at least one of the muffling chambers is labyrinthine;
the lengths of at least two of the muffling chambers are unequal, and the lengths of these two muffling chambers are between 0.0085 m and 0.85 m;
each of the communication ports connects to one of the muffling chambers, each of the muffling chambers is connected to the outside of the sound ingress and egress surface through one of the communication ports.

9. A refrigerating and freezing apparatus, comprising a cabinet and the muffling devices according to claim 1, wherein the muffling device is installed in the cabinet, to allow noise to enter the corresponding the muffling chambers through the communication ports.

10. The refrigerating and freezing apparatus according to claim 9, wherein,
the cabinet is provided with an airflow hole for airflow through, the sound ingress and egress surface of the muffling device being part or all of a periphery wall surface of the airflow hole; and/or,
the cabinet is provided with an airflow channel for airflow through, the sound ingress and egress surface of the muffling device being part of a peripheral wall surface of the airflow channel.
